(19) United States
(12) Patent Application Publication
(10) Pub. No.: US 2006/0278074 A1
(43) Pub. Date: Dec. 14, 2006

(54) Electrostatic air purifier with a laterally removable collection grid module

(76) Inventors: Dan Y. Tseng, Palos Verdes Estates, CA (US); David N. Kaye, Granada Hills, CA (US); Ling Ling, Changsha City (CN); Qi Zhiqiang, Changsha City (CN); Wang Bosheng, Hunan Province (CN); Hu Lu, Xianguan City (CN); Kang Cong, Taiyuan City (CN); Chung Ho Chang, Torrance, CA (US); Ma Tao, (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/150,724

(22) Filed: Jun. 9, 2005

(51) Int. Cl. B03C 3/00

(52) U.S. Cl. 95/57

(57) ABSTRACT

An air purification system includes an electrostatic collection grid module inside the housing of the system to remove particulate matter from the air flowing through the housing. The collection grid module is removable from a side of the housing. The collection grid module is equipped with a handle and a release mechanism. A user may draw out the collection grid module from the housing by pulling the handle while activating the release mechanism. Thus, the collection grid module may be cleaned with ease.

### BACKGROUND

1. Field of the Invention

Embodiments of the invention relate to an indoor electrostatic air filtration system. Specifically, embodiments of the invention relate to mechanisms and methods for cleaning an indoor electrostatic air filtration system.

2. Background

Air quality in the indoor setting is a common concern for individuals with asthma, allergies and similar respiratory problems and conditions. Many of these conditions are exacerbated by the presence of particulate matter inside the home or office space of the individual. Particulate matter may include pet dander, dust, tobacco, smoke, pollen and similar substances. In addition, airborne microorganisms that live on particulate matter are also a health concern.

Air quality in many areas of the country is worsening, making environmental air unhealthy to breathe. Some of the common pollutants that cause poor environmental air quality include particulate matter that comes from the exhaust of vehicles, such as diesel engines in trucks and ships. Other particulate matter that contributes to poor environmental air quality comes from industrial sites and power plants that release toxic particulate matter into the air.

Hazardous particulate matter enters the home through open or poorly insulated doors and windows, as well as through air conditioning and heating units that draw the air from outside of the home. This particulate matter may remain airborne in the house and may be inhaled by individuals occupying the home.

Electrostatic air purifiers have become widely accepted as a means for improving air quality. However, as a result of the air purification, particulate matter tends to accumulate inside the purifiers and adversely affect the continuing operations of the purifier. The efficiency of the purifier decreases if the internal component of the purifier is not adequately cleaned.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 shows an embodiment of an electrostatic air purification system;

FIG. 2 shows an user interface provided on a front cover of the air purification system;

FIG. 3 shows the user interface of FIG. 2 with the front cover removed to show internal components;

FIG. 4 shows an alternative embodiment of the user interface;

FIG. 5 shows internal components of the alternative embodiment of the user interface of FIG. 4;

FIG. 6 shows an exploded view of the air purification system;

FIG. 7 shows a detailed view of internal components located at the bottom portion of the air purification system;

FIG. 8 shows the principle of operation of air purification;

FIG. 9 shows an embodiment of an electrostatic collection grid module of the system with the side coverings removed to expose the internal structure;

FIG. 10 shows the collection grid module removed from the housing of the air purification system;

FIG. 11 shows an alternative embodiment of the collection grid module having a rotate-type locking mechanism;

FIG. 12 shows a front view of the collection grid of FIG. 11;

FIG. 13 shows a separator module removed from the collection grid module;

FIG. 14 shows a cleaning mechanism for cleaning electrode wires of the system; and

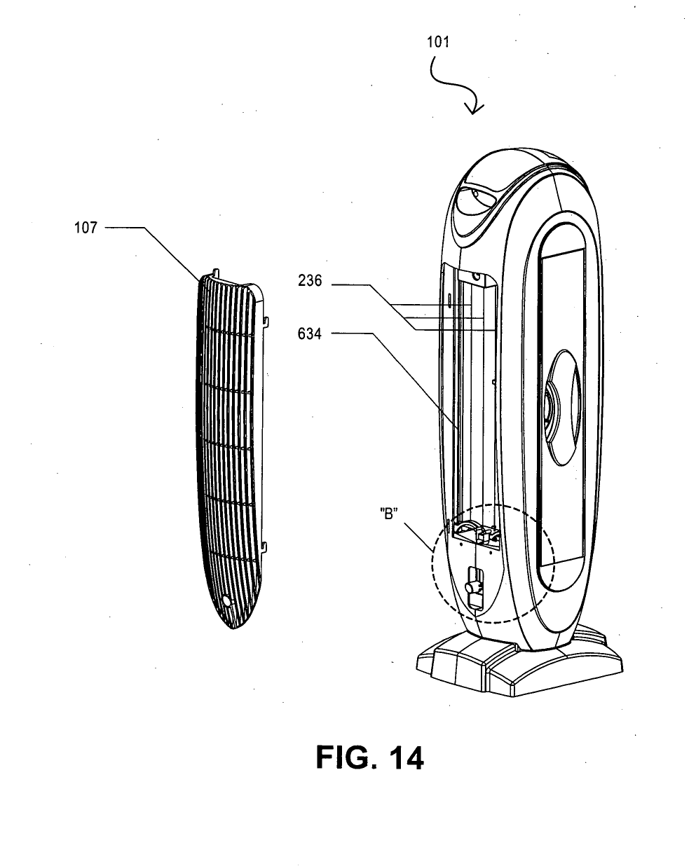

FIG. 15 shows a detailed view of the cleaning mechanism.

### DETAILED DESCRIPTION

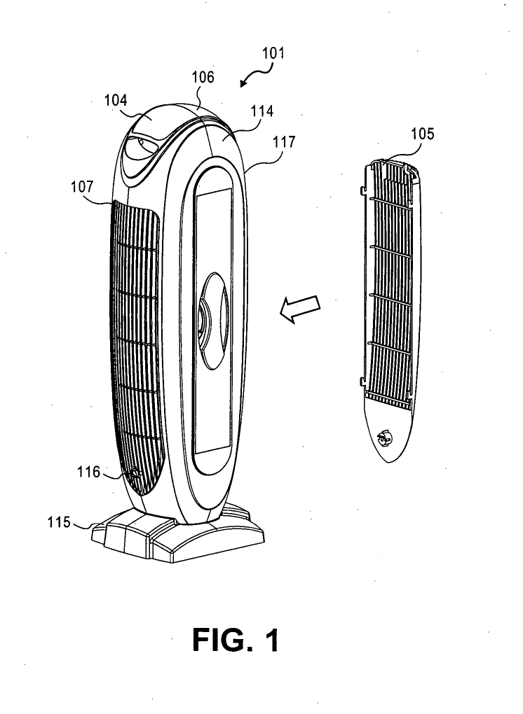

FIG. 1 is a diagram of one embodiment of an electrostatic air purification system. In one embodiment, the air purification system 101 is disposed in an upright housing to be placed on the floor of a room, on a table or similarly situated in a room of a house or business. In one embodiment, the housing 117 may have a tall upright design. In another embodiment, the housing may have other shapes that may be primarily horizontal, circular, square or similarly designed. The housing may be set on a base 115. The base 115 may provide a flat platform for the housing 117 of the air purifier system 101 to be set upon. The base prevents the housing 117 from being easily knocked over by a passersby, household pets, children, and similar causes of incidental external forces. In another embodiment, a base may not be utilized. For example, the housing may be circular, have a low profile and no base.

In one embodiment, the air purification system 101 may have a set of grills that allow air to flow through the housing 117. In one embodiment, an inlet grill 107 and an outlet grill 105 may be removably attached to the housing 117. Grills 105 and 107 may define a set of openings to provide space for air to flow through the housing 117. The grills 105 and 107 may be snap fit, form fit, screwed in, or similarly attached to the housing to facilitate assembling and disassembling. In one embodiment, the grills 105 and 107 are attached to the housing 117 with a snap installed behind the grills. A release mechanism, such as a button 116, releases the snap to allow the removal of the grills 105 and 107. Thus, a user may easily clean the grills 105 and 107 or access to the internal components of the system 101. In another embodiment, any type of protective opening that allows airflow through the housing 117 while preventing access to the internal components when in place may be used.

The housing 117 may also have a set of removable side panels, for example, right housing (not shown) and left housing 114. These side panels may be form fit, snap fit, screwed in, or similarly attached to the housing 117. Removal of side panels may allow access to the internal components of the system 101. This allows easy access for purposes of maintaining or replacing the internal components.

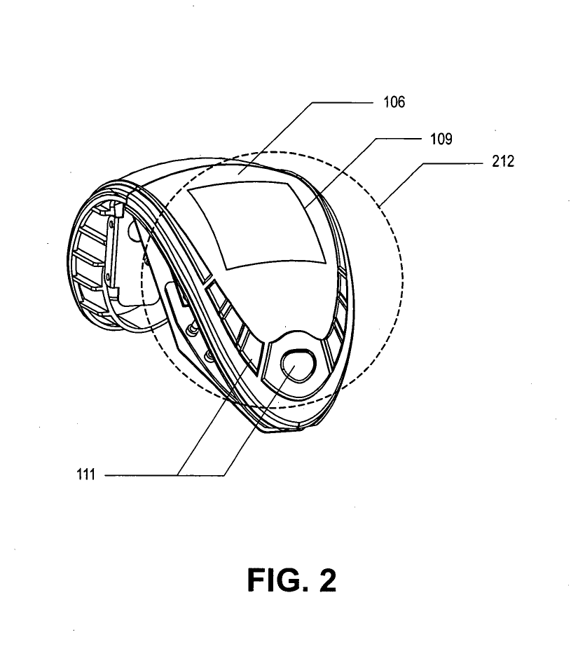

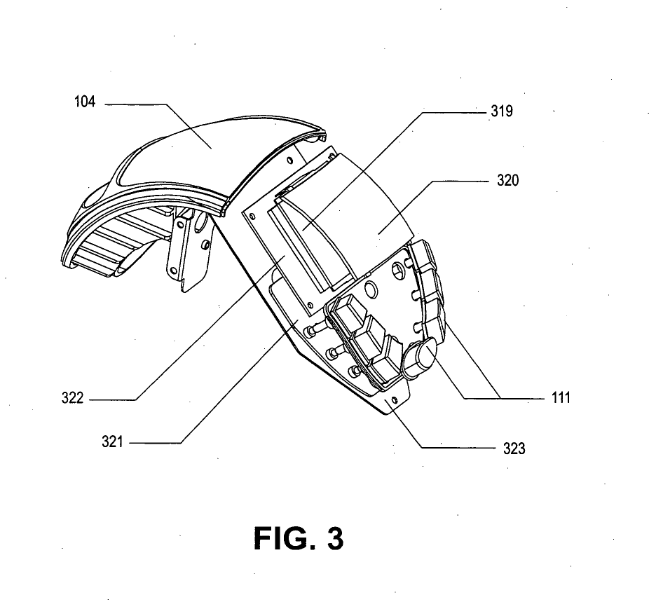

In one embodiment, the top portion of the housing 117 may include one or more removable covers; for example, a front top cover 106 and a rear top cover 104. FIG. 2 shows a user interface 212 located on the front top cover 106. FIG. 3 shows the user interface 212 with the front top cover 106 removed to show the internal components. The user interface 212 may include a set of buttons 111 and a display device 109 that respectively serve as an input and an output mechanism for a control system that manages the settings and operation of the system 101. In the embodiment shown in FIG. 3, the control system is implemented as a function board 321 fastened to the inner side of the front top cover 106 by screws, snap, or similar fastening device. Components of the user interface 212 may be mounted on a bracket of sheath circuit and fastening mechanism 323.

In one embodiment, the buttons 111 may be used to interact with the control system 321 to adjust the settings of the system 101. The buttons 111 may have any configuration or size. The buttons 111 may be backlit for easy viewing or identification in poorly lit environments. Separate buttons may be provided for control of the lights, negative ion generator, electrostatic collection module, ultraviolet light, control timer, operation mode, system lock, temperature unit, clock setting, power and similar features and settings. In another embodiment, other types of input mechanisms may be utilized. Other input mechanisms may include knobs, switches, touch screens, and similar input mechanisms.

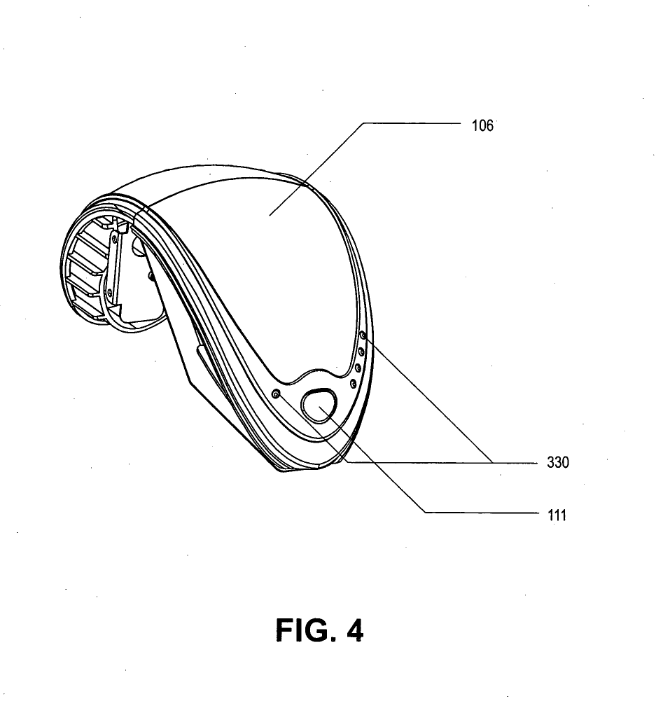

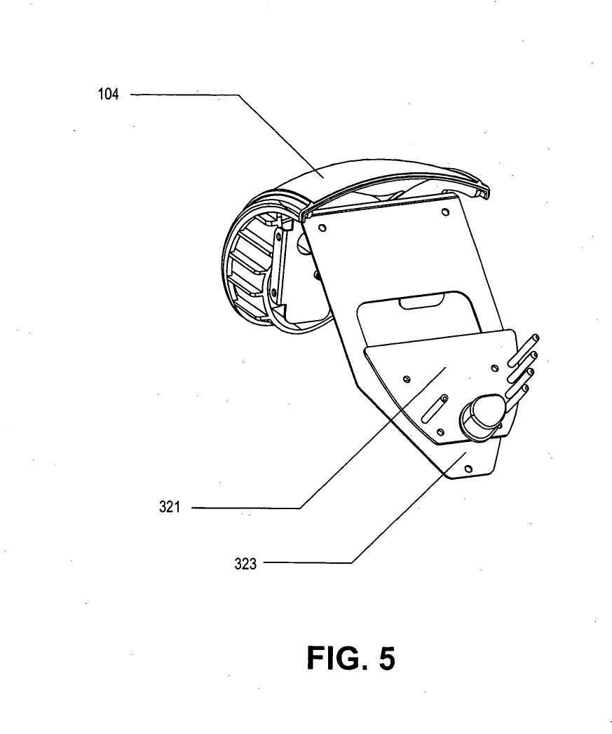

In one embodiment, the display device 109 may include a liquid crystal display (LCD) 319 controlled by a LCD control board 322. The LCD 319 may be viewed from outside the housing 117 through a transparent window 320. In another embodiment, as shown in FIG. 4, the display may be a set of light emitting diodes (LEDs) 330, each indicating a status of a functional module. FIG. 5 shows the internal components of the LED display 330. Alternatively, the display may be a cathode ray tube based display, a plasma screen, a bio-organic based display or similar display system to show the operating status of the system 101. The display may be used to provide feedback to the user based on his or her interaction with the input mechanism. In one embodiment, the display may also be backlit to allow easy viewing in poorly lit environments.

Referring to FIG. 3 and FIG. 5, the control system 321 as shown is situated within the housing 117 near the display device 109. In another embodiment, the control system 321 may be situated anywhere in the housing 117 in communication with the display device 109, the buttons 111, and sensors which will be described below. In one embodiment, the control system 321, the input and output mechanisms, and the internal wiring connected thereto may be removable to install components having different functionality. In alternative embodiments, the control system 321 may be a general purpose processor coupled to a memory storage device, a field programmable gate array (FPGA), a specialized integrated circuit and storage device or similar system. The control system 321 may utilize a real time operating system, embedded software and similar components to implement the control interface for the air purification system 101.

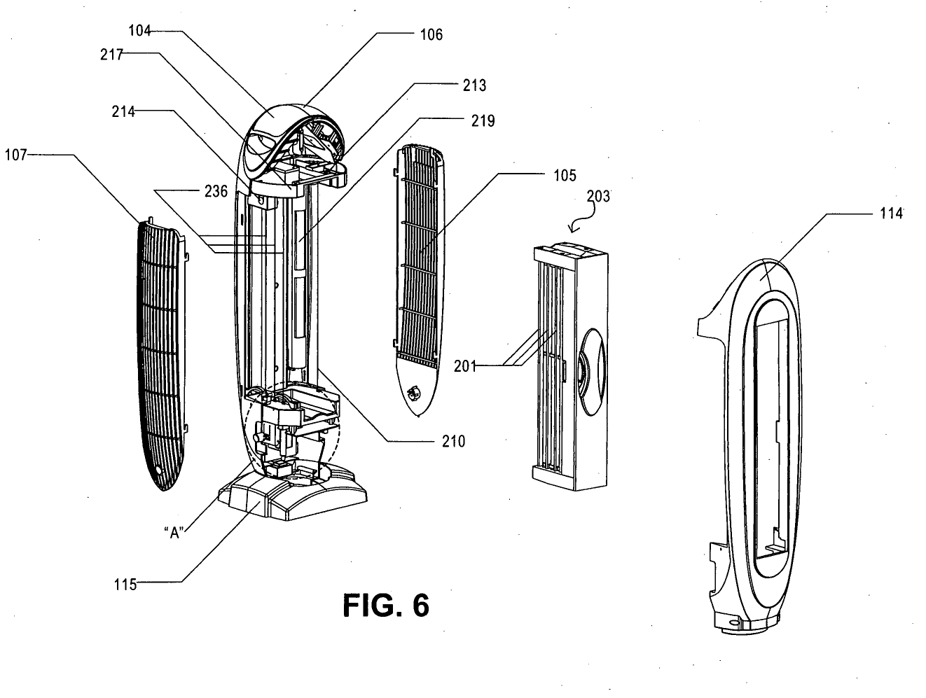

FIG. 6 is a diagram of one embodiment of the air purification system 101 with the exterior paneling removed to show the internal components of the system. In one embodiment, the system 101 may include a set of sensors situated in the housing 117 to receive input from ambient air. The sensors detect ambient air quality and relay that information to the control system 321. The sensors may detect particulate matter levels in the air of the environment and output a signal indicating the level of detected particulate matter on the display device 109. The sensors may detect other environmental data including temperature, humidity and similar information. In one embodiment, the set of sensors may include a dust sensor 214 to detect different types of particulate matter, for example, dust, odor, and pollens. The dust sensor 214 may generate outputs indicating the level of each type. In one embodiment, the set of sensors may include a temperature and humidity sensor 213 to detect temperature and humidity. The set of sensors may be situated in any part of the housing 117 where they are exposed to air from the environment. In one embodiment, the set of sensors are mounted on an upper bracket 217 located at the upper internal chamber of the housing 117.

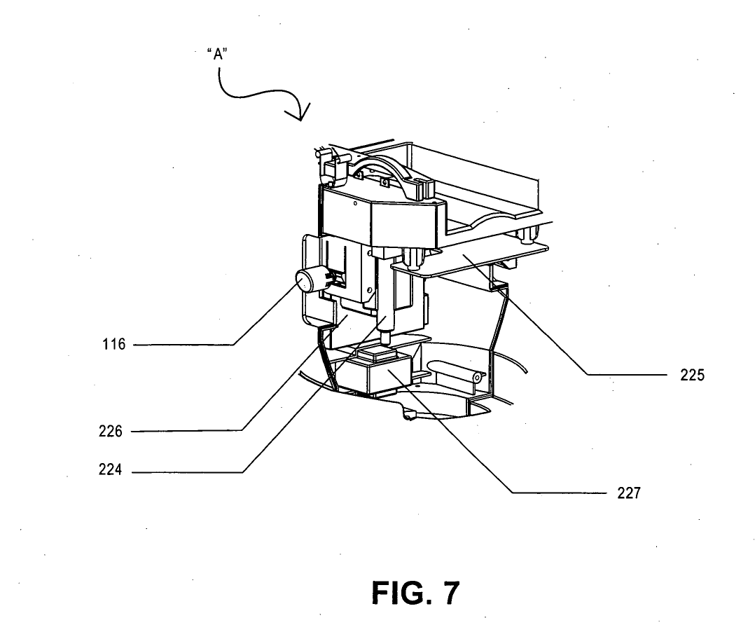

Referring to FIG. 6 and FIG. 7, the system 101 may also include high voltage output control and power supply control components to supply and control high voltage power to the system 101. FIG. 7 illustrates an embodiment of the high voltage output control and power supply control components situated in the bottom portion of the housing 117, including a high voltage pack 224 to generate high voltage power, a control board 225 to control the output power, a rectifier 226, and a transformer 227. The transformer 227 transforms incoming alternating current (AC) from a wall socket into a direct current (DC) to be utilized by the components of the system 101. In one embodiment, the transformer 227 or a similar device may provide power to the components in the system 101 at a constant voltage. The control system 321 may request the control board 225 for an adjustment of the power provided to each component of the system 101.

Referring back to FIG. 6, the system 101 may include one or more self-contained negative ion generators 210. The negative ion generator 210 may be a separate unit from a collection grid module 203 to be described later. The negative ion generator 210 may be situated in any position along the airflow path within the housing 117. In one embodiment, the negative ion generator 210 may charge the air and particles in the air with a negative charge to generate positive or negative ions in the air. Negative ions may remove odor and promote good health. In another embodiment, the negative ion generator 210 may inject negative ions into the air. The negative ion generator 210 may function to freshen the air and minimize odors in the air. The negative ion generator 210 may be enabled or disabled by the user through the user interface 212 and the control system 321. The negative ion generator 210 may be implemented as a long metal wire, a metal sheet with a plurality of pointed projections, or similarly implemented. The negative ion generator 210 may receive power from the high voltage pack 224, or the negative ion generator 210 may be a self-contained unit that uses commercial voltage power supplied from a wall socket or use power supplied by a battery.

In one embodiment, the system 101 may also include an ultraviolet germicidal device 219 to irradiate the air in the housing 117 to kill bacteria and other microorganisms. In another embodiment, other types of irradiating devices may be used to kill the microorganisms in the air within the housing 117. The ultraviolet germicidal device 219 may be situated anywhere in the housing 117 along the airflow path. The ultraviolet germicidal device 219 may include a photocatalyst filter, an ultraviolet light, and fastening means (e.g., snaps, screws, and brackets) for securing the device to the housing 117. The ultraviolet germicidal device 219 may have a long cylindrical shape running the length of the housing 117. In another embodiment, the ultraviolet germicidal device 219 may have any shape that conforms to the shape of the housing 117, the internal chamber of the system 101, or shape of the internal air pathway. The operation of the ultraviolet germicidal device 219 may be controlled by the control system 321. The control system 321 may enable and disable the ultraviolet light and control power levels of the light. In one embodiment, a lampshade, a shield, or an obstructing wall may be present in the interior of the housing 117 to block the ultraviolet light from exposing to the outside through the grills 105 and 107 or radiating on the users.

In one embodiment, the system 101 includes the collection grid module 203 to collect the particulate matter flowing through the housing 117 and a set of electrode wires 236 to ionize the air as the air passes through the module. The collection grid module 203 may include a set of collection plates 201 to collect the particulate matter. The set of electrode wires 236 may be separated from the collection grid module 203 and affixed to the housing 117 along the length of the internal chamber of the housing. In an alternative embodiment, the electrode wires 236 may be attached to the collection grid module 203.

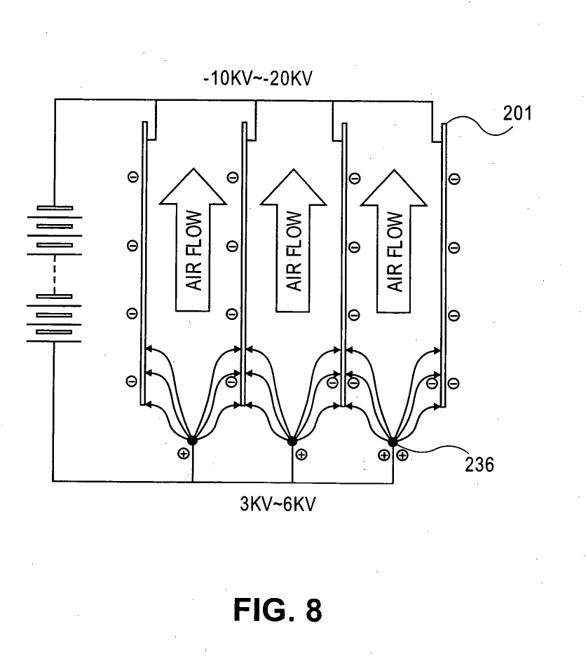

FIG. 8 shows the principle of operation of the air purification. When an adequate high DC voltage (e.g., 3 KV-6 KV) is applied to the electrodes wires 236, a nonuniform electrical field is formed between the electrode wires 236 and the collection plates 201. The electrical field imparts a positive charge to particulate matter in the air inside the housing 117 and separates the particulate matter from the airflow under the Coulomb force. The collection plates 201 may be electrically grounded or negatively charged (e.g., −10 KV-−20 KV) to collect the positively charged particulate matter. The collection plates 201 and the electrode wires 236 may be made of metal or similar materials.

Referring back to FIG. 6, in one embodiment, the collection grid module 203 is located inside the housing 117 and is removable from the housing. The collection grid module 203 may be made of materials that are not corroded or damaged by the presence or water or the heat levels generated during the washing process of a dishwashing machine. Also, the collection grid module 203 may be watertight to prevent the accumulation of water inside the module during the washing process. The shape of the collection grid module 203 may be square, circular, oval, or similarly designed.

In one embodiment, the upper and lower ends of the collection grid module 203 may have electrical contacts that when situated in the housing 117 are in contact with complementary electrical contacts in the housing. In one embodiment, the upper and lower ends of the collection grid module 203, as well as the exposed contacts may form a watertight seal to protect the wiring in the interior of the collection grid module. In another embodiment, the collection grid module 203 may not be watertight, but may have internal components that are not corroded or damaged by exposure to water or the temperature levels generated in a dishwasher. The housing of the collection grid module 203 may be made of aluminum alloy, stainless steel, and plastic materials such as POM (polyoxymethylene), PBT (polybutylene terephthalate), or similar materials.

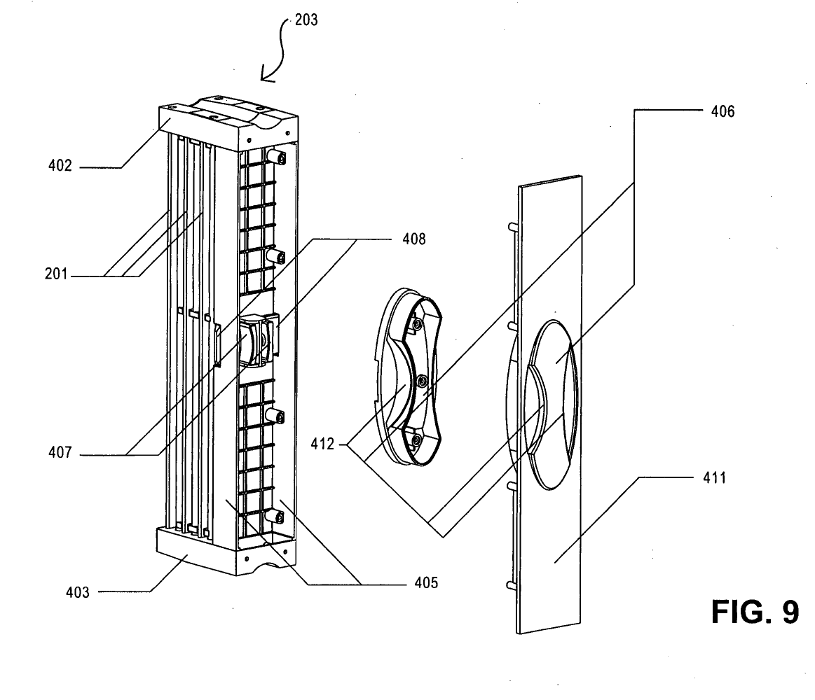

FIG. 9 provides an exploded view of an embodiment of the collection grid module 203. In one embodiment, the collection plates 201 are parallelly secured between positioning slots of an upper bracket 402 and a lower bracket 403 of the collection grid module 203. The collection plates 201 may be connected as one pole by a conducting device, for example, a metal sheet. The collection plates 201 receive power from the high voltage pack 224 through a metal contact spring attached to the lower bracket 403. The metal contact spring forms an electrical contact with a high voltage electrode of the high voltage pack 224 only when the collection grid module 203 is situated in the housing 117. In one embodiment, separate electrical contacts on the collection grid module 203 allow input from the control system 321 that may be used to enable or disable the module or adjust the power level of the module. A supporting bracket 405 connects the upper bracket 402 and the lower bracket 403 to structurally secure and support the collection grid module 203.

The collection grid module 203 may include a handle 406 disposed on a side panel 411 of the module and a release mechanism for releasing the module from the housing 117. The side panel 411 constitutes part of the right housing 114. In one embodiment, the handle 406 has a curved portion 412 to facilitate holding by a user. Disposed along the curved portion 412 of the handle 406 are two press-type release buttons 407. The buttons 407 are attached to the collection grid module 203 and may be pressed toward each other.

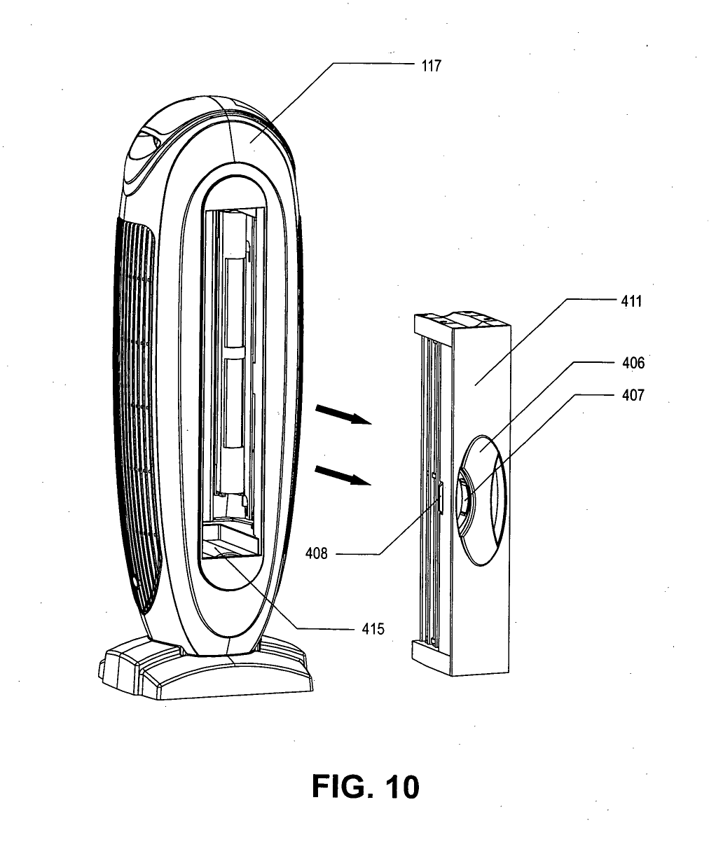

Referring to FIG. 9 and FIG. 10, the buttons 407 may serve as a locking mechanism to prevent the collection grid module 203 from sliding out unintentionally. The buttons 407 are coupled to a pair of projection tabs 408 protruding from both sides of the supporting bracket 405. A spring installed in the buttons 407 biases the projection tabs 408 into engagement with the housing 117. The buttons 407 counter the spring bias to hold the collection grid module 203 inside the housing 117. When the buttons 407 are pressed toward each other, the projection tabs 408 retract into the collection grid module 203 to allow removal of the module 203. The spring provides flexibility such that the buttons 407 may move left and right during shipment or similar perturbation but are capable of holding the collection grid module 203 in place.

FIG. 10 shows that the collection grid module 203 may be removed from a side of the housing 117 for cleaning, maintenance, or any purposes. A user may reach into the handle 406 to access the buttons 407. By holding the handle 406 while pressing the buttons 407 toward each other, a user may release the collection grid module 203 and pull out the module from the side where the handle 406 is located. In alternative embodiments, the collection grid module 203 may be removed from any of the front, rear, left, and right sides, or any periphery of the housing 117. In one embodiment, the collection module 203 grid is removed along a substantially horizontal path, e.g., a path defining an approximity 90° angle with a vertical axis of the air cleaner. In other embodiments the collection module may be removed along a 45° path forming other angles relative to the vertical axis, e.g., 30° 45°, 60°. By removing the collection grid module laterally, rather than vertically, removal need not impact display and control system placement and operation.

In one embodiment, the projection tabs 408 each have a sloped side facing the inner chamber of the housing 117. The projection tabs 408 retract when a force is applied to the sloped side. When a user pushes the collection grid module 203 back into the housing 117, the projection tabs 408 retract as the sloped sides contact the outer covering of the housing. After the collection grid module 203 is returned to the housing 117, the projection tabs 408 stretch out under the force of the spring to engage the module within the housing.

The collection grid module 203 may be removed from and returned to the housing 117 along one or more glide tracks 415 installed inside the housing. In one embodiment, the glide tracks 415 are installed at the bottom of the inner chamber of the housing 117. The shape of the glide track may be arc, circular, square, or similarly designed.

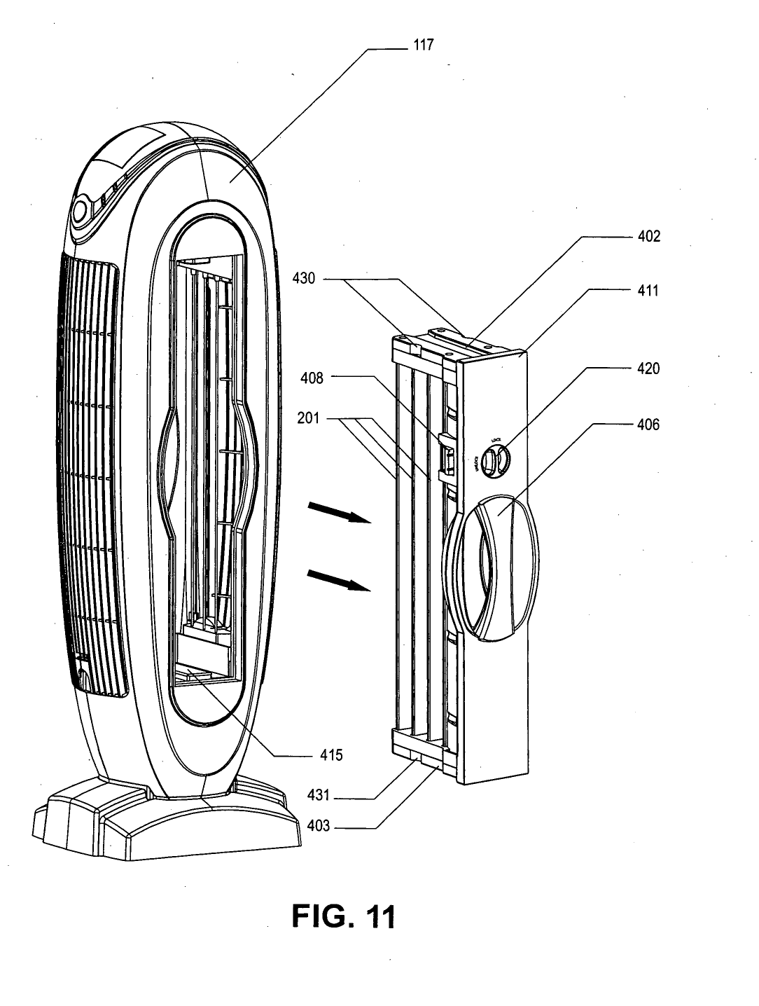

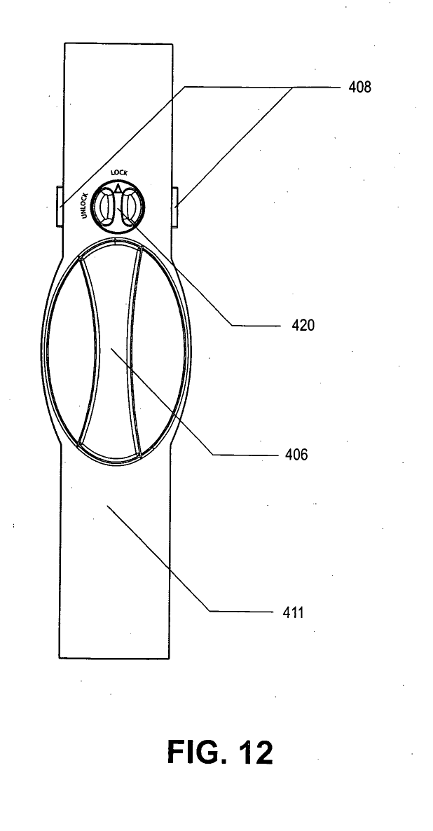

FIG. 11 and FIG. 12 show an alternative embodiment of the collection grid module 203 having a rotate-type release mechanism. Disposed on the side panel 411 is a rotate-type dial 420 which may be turned to either a LOCK or UNLOCK position. In alternative embodiments, the positions of the LOCK and UNLOCK may be anywhere along the perimeter of the dial 420. The dial 420 is coupled to projection tabs 408. When the dial 420 is turned to the UNLOCK position, the projection tabs 408 retract into the collection grid module 203. Thus, a user may pull out the collection grid module 203 by the handle 406. When returning the collection grid module 203 to the housing 117, a user may slide the module along the glide tracks 415 back into the housing with the dial 420 in the UNLOCK position. After the collection grid module 203 is back inside the housing 117, a user may turn the dial 420 to the LOCK position. The two projection tabs 408 when in the LOCK position protrude from the sides of the collection grid module 203 to secure the module within the housing 117.

In the embodiment of FIG. 11, the collection grid module 203 include one or more concave portions 430 and 431 at the upper bracket 402 and lower bracket 403 to prevent the module from sliding out unintentionally. On the corresponding surface inside the housing 117, one or more metal spring sheets are installed to couple with the concave portions 430 and 431. When the collection grid module 203 is returned to the housing 117, the metal spring sheets insert into the concave portions 430 and 431 to secure the module within the housing. In an alternative embodiment, the collection grid module 203 may include one or more metal blocks or metal plates to mate with one or more magnets affixed to the housing 117. The magnetic force between the magnets and the metal pulls the collection grid modules 203 toward the magnets, thus keeping the module in place.

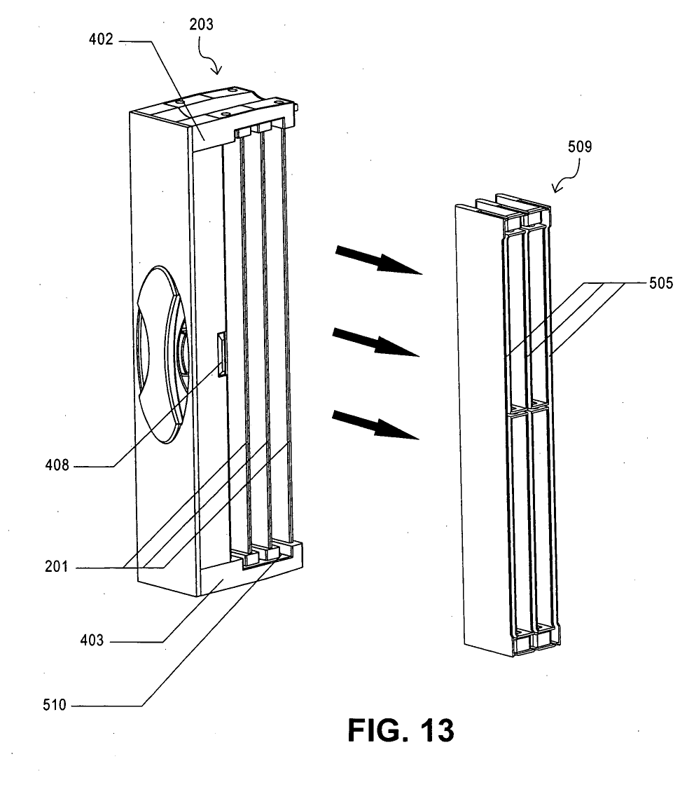

In one embodiment, the collection grid module 203 may also include a removable separator module 509 to promote efficiency of air purification. Referring to FIG. 13, the separator module 509 may be easily pushed out of the collection grid module 203 along the runners 510 installed inside the upper and lower brackets 402 and 403. The separator module 509 includes a plurality of separator plates 505 running in parallel with the collection plates 201. Each of the separator plates 505 when inserted into the collection grid module 203 serves to decrease the distance between the adjacent collection plates 201. Thus, the separator module 509 prevents air from flowing through the uniform zone of the electrical field, and the airborne particles move to the collection plates 201 under the Coulomb force with high efficiency.

The collection grid module 203 and the separator module 509 form an integrated unit when the separator module 509 is inserted into the collection grid module 203. The separator module 509 may be implemented as one self-contained unit, or several units integrated as one by screws or similar fastening devices. The separator module 509 may be made of plastic, bakelite, beaverboard, or similar insulating materials.

The separator module 509 may be held inside the collection grid module 203 by a snap mechanism installed in the runners 510 to prevent the separator module from sliding out unintentionally. The snap mechanism may be a plastic snap integrated into the runner 510 or similar parts of the system 101, or a separate elastic sheet made of metal.

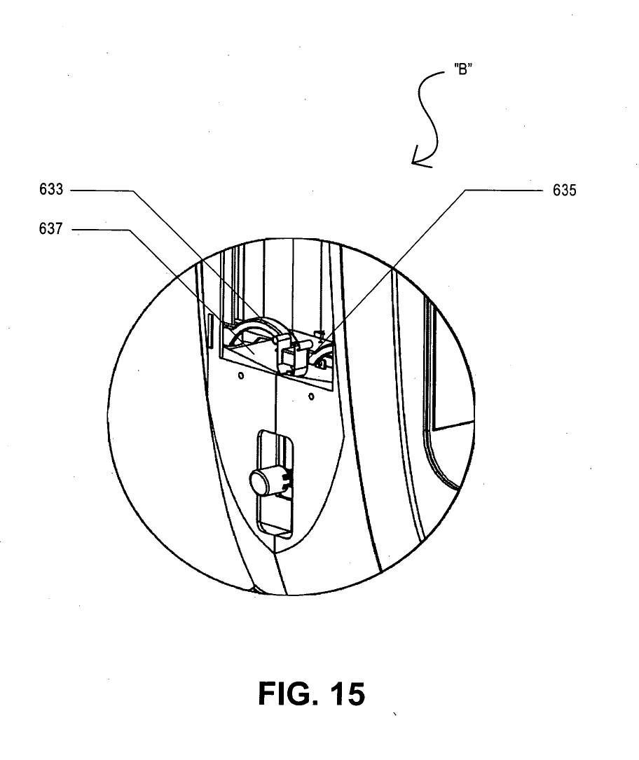

FIG. 4 shows an embodiment of an electrode wire cleaning mechanism for cleaning the electrode wires 236 attached to the housing 117. The inlet grill 107 may be removed to expose the electrode wires 236 and the cleaning mechanism. FIG. 15 shows a detailed view of the cleaning mechanism after the inlet grill 107 is removed.

In one embodiment, the electrode wire cleaning mechanism includes a cleaning plate 633 moveable along the length of the housing 117. Glide tracks 634 installed on the inner sides of both the left housing 114 and left housing guide the movement of the cleaning plate 633. In one embodiment, the cleaning plate 633 includes a layer of soft material for collecting dust upon contact. The soft material may be made of polyvinyl chloride (PVC), ethylene vinyl acetate (EVA), polypropylene (PP), or similar materials. In an alternative embodiment, the soft material may be an elastic sheet. A keep plate, for example, an metal plate or similarly designed, is used to hold the soft material tightly. The cleaning plate 633 may be made of plastic, bakelite, ceramics or similar insulating materials.

To clean the electrode wires 236, a user may simply move the cleaning plate 633 up and down the wires. The cleaning plate 633 and the soft material inside the plate press tightly against the electrode wires 236 during the movement. Thus, the soft material collects the dust accumulated on the electrode wires 236.

In one embodiment, the cleaning plate 633 may be secured to the housing 117 by a metal elastic clip 635 when not in use. When the cleaning plate 633 glides to the bottom of the housing 117 after cleaning, a user may lock the cleaning plate in place by inserting an end of the plate into the metal elastic clip 635. In another embodiment, one or more metal blocks are affixed to the bottom of the cleaning plate 633. One or more magnets are affixed to a bottom bracket 637 located at the bottom of the inner chamber of the housing 117. Thus, the magnetic force between the magnets and the metal pulls the cleaning plate 633 toward the bottom bracket 637 to hold the cleaning plate in place.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. An apparatus comprising:
a housing; and
an electrostatic collection grid module inside the housing to remove particulate matter from the air flowing through the housing, wherein the collection grid module removable from the housing at an angle to a vertical axis of the housing.

2. The apparatus of claim 1 wherein the collection grid module comprises:
a handle located on a side panel of the collection grid module; and
a release mechanism.

3. The apparatus of claim 2 wherein the release mechanism comprises:
a spring to bias a catch into engagement with the housing; and
a button which when actuated counters the spring bias.

4. The apparatus of claim 2 wherein the side panel constitutes part of the housing.

5. The apparatus of claim 1 further comprising:
a plurality of magnets to magnetically couple the collection grid module within the housing.

6. The apparatus of claim 1 further comprises:
one or more glide tracks disposed within the housing to define the removal path for the collection grid module.

7. The apparatus of claim 1 wherein the collection grid module is dishwasher safe.

8. The apparatus of claim 1 wherein the collection grid module comprises:
a plurality of collection plates parallelly connected as one pole; and
a metal contact spring electrically coupled to the plates to provide a charge thereto.

9. The apparatus of claim 1 wherein the housing includes one or more metal spring sheets to couple to one or more concave portions of the collection grid module within the housing.

10. The apparatus of claim 1 further comprising:
a plurality of electrode wires; and
a cleaning mechanism to moveably contact the electrode wires along a substantial length of the electrode wires.

11. The apparatus of claim 1 further comprising:
a separator module engaged inside the collection grid module, wherein the separator module is removable from the collection grid module.

12. The apparatus of claim 11, wherein the collection grid module with the separator module inside is dishwasher safe.

13. The apparatus of claim 1 wherein the angle is one of a 90°, 60°, 45°, and 30° angle.

14. A method comprising:
holding the handle of an electrostatic collection grid module located inside a housing;
pulling the handle to apply a force having a lateral component; and
removing the collection grid module from the housing at an angle to a vertical axis of the housing.

15. The method of claim 14 wherein removing the collection grid module is from a side of the housing where the handle is located.

16. The method of claim 14 further comprising:
activating at least one release on an inner side of the handle.

17. The method of claim 14 further comprising:
turning a dial on a side panel of the collection grid module.

18. The method of claim 14 wherein the removing the collection grid module comprises:
sliding the collection grid module out of the housing along one or more glide tracks installed inside the housing.

19. The method of claim 14 further comprising:
cleaning the collection grid module; and
replacing the collection grid module within the housing.

20. The method of claim 19 wherein cleaning comprises:
running the collection grid module through a wash cycle in an automatic dish washer.

21. The method of claim 19, wherein cleaning comprises:
removing a separator module from the collection grid module; and
running the collection grid module through a wash cycle in an automatic dishwasher.

22. The method of claim 14 wherein the angle is in the range of 30°-90°.
